(19) United States
(12) Patent Application Publication
(10) Pub. No.: US 2002/0157636 A1
(43) Pub. Date: Oct. 31, 2002

(54) Two-dimensional positive rotary displacement engine

(76) Inventor: James B. Klassen, Irvine, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/072,619

(22) Filed: Feb. 8, 2002

Related U.S. Application Data
(60) Provisional application No. 60/267,969, filed on Feb. 8, 2001.

(51) Int. Cl. F02B 53/00

(52) U.S. Cl. 123/246; 123/204; 418/170; 418/171; 418/165

(57) ABSTRACT

A two-dimensional rotary displacement device comprises a housing, an outer rotor and at least one inner rotor. The axes of rotation of the outer rotor and the at least one inner rotor are parallel. A predefined geometrical relationship exists between the outer and inner rotors such that the scale of operative circumference (or diameter) from the inner rotor with respect to the outer rotor is preferably an integer value. In one embodiment, the device is used as a compressor that positively displaces a gas. In a modified embodiment, the device includes an exit port, which has a location that can be adjusted with respect to the housing and is adjustable so as to decrease the pressure differential between an exit chamber and the exit pressure. In another embodiment, the device can be used as an external combustion engine wherein compressed gas is discharged from an exit chamber to a combustion chamber where the volume of gas is increased due to heating of the gas and a portion of the discharge gas is directed to the rotor assembly and the remaining volume of gas can be used for a “hot blow” thrust or other use or directed to an additional rotor assembly to induce a torque to an output shaft attached to the outer rotor of one or both of the rotor assemblies. In another embodiment, a portion of the the compressed gas can be used for “cold blow thrust or other purpose instead of directing all of the compressed gas through the combustor.

### PRIORITY INFORMATION

This application claims priority under 35 U.S.C. §119(e) of Provisional Application 60/267,969 filed Feb. 8, 2001, the entirety of which is herein incorporated by reference.

### BACKGROUND OF THE INVENTION

1. Field of the Invention

The preferred embodiments of the present invention relate to a positive displacement engine and more particularly to a two-dimensional positive displacement engine.

2. Description of the Related Art

Engines convert one form of energy into another. For example, combustion engines convert chemical energy into kinetic energy while pumps convert kinetic energy into pressure.

Combustion engines are typically classified as either internal or external combustion engines. Most internal combustion engines are reciprocating piston-type engines. This type of engine is widely used because of its relatively low cost of production and efficient sealing. A turbine is an example of an external combustion engine. As compared to a reciprocating piston engine, a turbine typically provides greater power due to its higher operating speed. Several attempts have been made to improve the performance of combustion engines. For example, rotating internal combustion engines, such as, the Wankel engine, seek to combine the advantages of turbines and reciprocating piston engines. The types of engines have demonstrated higher power to weight ratios as compared to reciprocating engines but typically have higher fuel consumption.

There are several types of pumps, such as, for example, positive displacement pumps, centrifugal pumps and impeller pumps. Positive displacement pumps are typically either reciprocating or rotary. Positive displacement pumps typically produce high pressures but operate at low speeds. Centrifugal pumps, in contrast, typically operate at high speeds but produce low pressures. U.S. Pat. No. 6,036,463 describes an attempt to combine the advantages of positive displacement pumps and centrifugal pumps.

Notwithstanding, the variety of efforts in the prior art to improve engine design there remains a need for an improved engine that has high power to mass ratio, a high efficiency and is relatively easy to manufacture.

### SUMMARY OF THE INVENTION

The present invention relates to a two-dimensional rotary displacement device that comprises, a housing, an outer rotor and at least one inner rotor. The axes of rotation of the outer rotor and the at least one inner rotor are parallel. A predefined geometrical relationship exists between the outer and inner rotors such that the scale of operative circumference (or diameter) from the inner rotor with respect to the outer rotor is preferably an integer value.

In one embodiment, the device is used as a compressor that positively displaces a gas. In a modified embodiment, the device includes an exit port, which has a location that can be adjusted with respect to the housing and is adjustable so as to decrease the pressure differential between an exit chamber and the exit pressure.

In another embodiment, the device can be used as an external combustion engine wherein compressed gas is discharged from an exit chamber to a combustion chamber where the volume of gas is increased due to heating of the gas and a portion of the discharge gas is directed to the rotor assembly and the remaining volume of gas can be used for a “hot blow” thrust or other use or directed to an additional rotor assembly to induce a torque to an output shaft attached to the outer rotor of one or both of the rotor assemblies. In another embodiment, a portion of the compressed gas can be used for “cold blow thrust or other purpose instead of directing all of the compressed gas through the combustor.

### BRIEF DESCRIPTION OF THE DRAWINGS

FIG. 1 is an top perspective view of a first embodiment of a rotary engine having certain features and advantages according to the present invention.

FIG. 2 is a top view of an outer rotor and an inner rotor of the rotary engine of FIG. 1.

FIG. 3 is a closer view of FIG. 2 illustrating the geometric relationship of the inner and outer rotor.

FIG. 3 is a top view of a housing of the rotary engine of FIG. 1.

FIG. 4 a schematic view illustrating the geometries of an outer reference circle and an inner reference circle;

FIG. 5 is a top plan view of a housing of the rotary engine of FIG. 1.

FIG. 6 is a top view of the outer and inner rotors illustrating a first position of a compression cycle.

FIG. 7 is a top view of the outer and inner rotors illustrating a second position of a compression cycle.

FIG. 8 is a top view of the outer and inner rotors illustrating a third position of a compression cycle.

FIG. 9 is a top view of the outer and inner rotors illustrating a forth position of a compression cycle.

FIG. 10 illustrates an external combustion engine comprising a first engine, a second engine and an external combustion chamber.

FIG. 11 illustrates a modified embodiment the engine of FIG. 10.

FIG. 12 illustrates another modified embodiment of the engine of FIG. 11.

FIG. 13 shows a modified rotary engine which includes two inner rotors.

FIG. 14 is a closer view of a portion of FIG. 13.

FIG. 15 shows an isometric view of another embodiment where a plurality of interior rotors are employed.

FIG. 16 is an isometric view showing a backside of the embodiment shown in FIG. 15.

FIG. 17 is an isometric view showing a modification to the embodiment of FIG. 15 where the casing provides openings for a pump configuration.

FIG. 18 is an isometric view showing a casing of embodiment shown in FIG. 17.

FIG. 19 is an isometric view showing the casing and the outer rotor of embodiment shown in FIG. 17.

FIG. 20 is an isometric view of an endcap for the embodiment shown in FIG. 17.

### DETAILED DESCRIPTION OF THE PREFERRED EMBODIMENT(S)

Throughout this description reference is made to top and bottom, front and rear. The device of the present invention can, and will in practice, be in numerous positions and orientations. These orientation terms, such as top and bottom, are used for aiding the description and are not meant to limit the invention to any specific orientation.

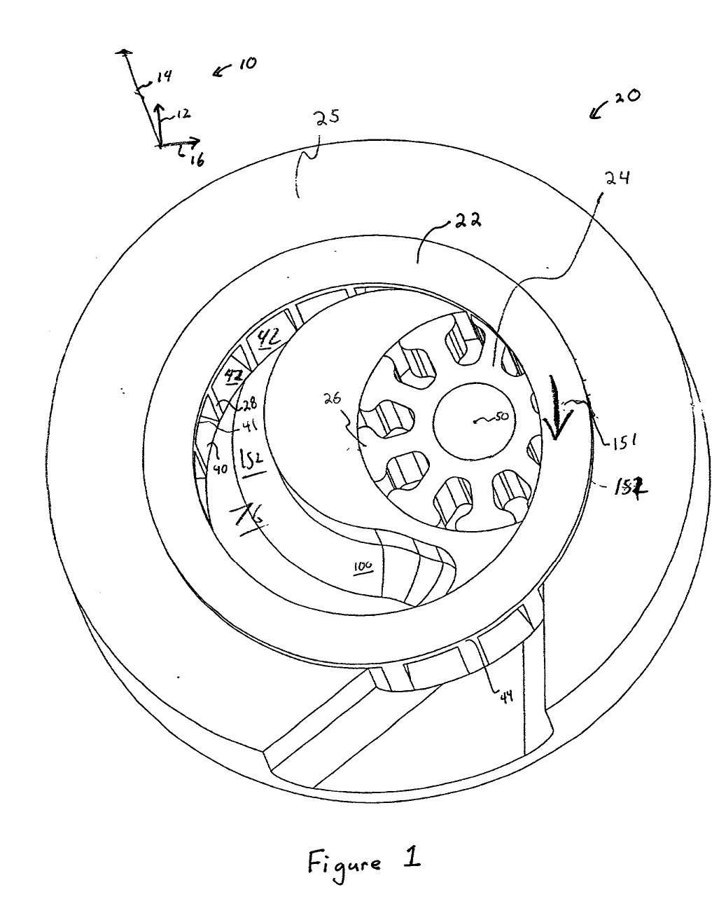

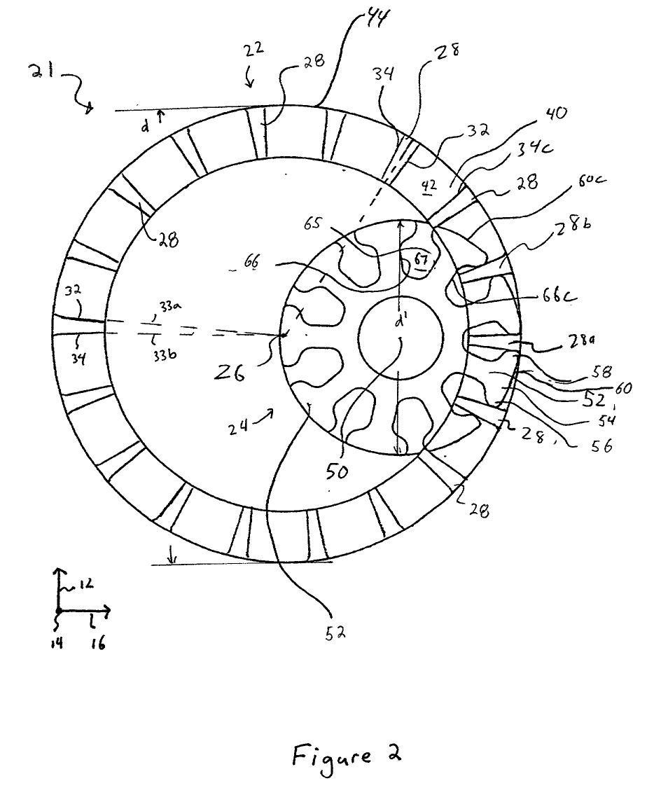

To aid the description, an axis system 10 will first be defined with reference to FIGS. 1 and 2. The axis system 10 includes a transverse axis 12, a crossword axis 14 that extends parallel to a first axis 26 and a second axis 50, which will be described below, and a wayward axis indicated 16, which is orthogonal to both the traverse and crossword axes 12, 14. In FIG. 2, the crossword axis 14 extends out of the page while the transverse and wayward axes 12, 14 lie within the page.

With initial reference to FIGS. 1 and 2, there is shown a first embodiment of an engine 20 having certain features and advantages according to the present invention. In this application, engine means a device that converts one form of energy into another form of energy and includes combustion engines (internal and external), pumps, compression devices, propulsion devices, etc. as will be apparent from the description below.

The engine 20 comprises an outer rotor 22, an inner rotor 24 and a housing 25. The inner rotor 24 and the outer rotor 22 form a rotor assembly 21. The outer rotor 22 has an outside diameter d and rotates about the first axis 26. The outer rotor 22 has a plurality of fins 28, that will be described in detail below. The inner rotor 24 has an outside diameter d′ and rotates about the second axis 50.

With particular reference to FIG. 2, the fins 28 are positioned generally about a central axis 30, which extends through the first axis 26. The fins 28 define a forward surface 32 and a rearward surface 34. The forward and rear surfaces 32, 34 are preferably substantially flat and define side axes 33a,b, which are offset by a distance o, which will described in more detail below. The outer rotor 22 further comprises a lower surface 40 and upper surface 41. As best seen in FIG. 1, a semi chamber 42 is defined by lower surface 40, upper surface 41, forward surface 32, rearward surface 34.

The outer rotor 22 includes a peripheral edge portion 44, which defines a circle about the first axis 26 and is located at the radially outward portion of the outer rotor 22. The peripheral edge 44 is adapted to intimately engaged the housing 25 to form a compression chamber as will be described below. The peripheral edge 44 defines the outside diameter of the outer rotor 22 and thus has a diameter d as described above.

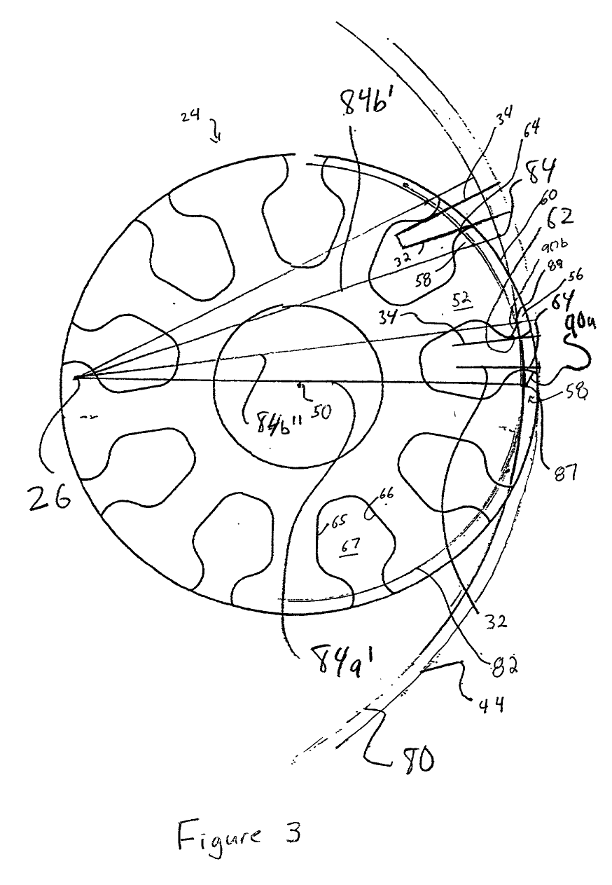

With continued reference to FIG. 2, the inner rotor 24 includes a plurality of legs 52. Each leg 52 has a foot portion 54 that comprises a heal portion 56 and a toe portion 58. The foot 54 further comprises a radialy outward surface 60, which extends from the foot portion 54 to the heal portion 56. As best seen in FIG. 3, the heal portion 56 defines a rear contact surface 62 that is adapted to engage the rear surface 34 of the fins 28. In a similar manner, the toe portion 58 defines forward contact surface 64 that is adapted to engage the forward surface 32 of the fins 28. Each leg 52 further has a internal rearward surface 65 and an internal forward surface 66, which face one another and define an inner rotor chamber 67.

The geometric relationship between the inner and outer rotors 24, 22, will now be described. FIG. 2 shows and embodiment where the wheel 24 has nine legs 52 with nine corresponding foot portions 54. The radially outward surface surfaces 60 of the foot portions 54 define at least in part a circular cylinder with a diameter d′, which rotates about the second axis 50. As shown in FIG. 2, there are eighteen semi chamber regions 42 of the outer rotor 22. As such, the number of semi chamber region 42 in the outer rotor 22 in the illustrated embodiment shown in FIG. 2 is twice the number of legs 52 of inner rotor 24.

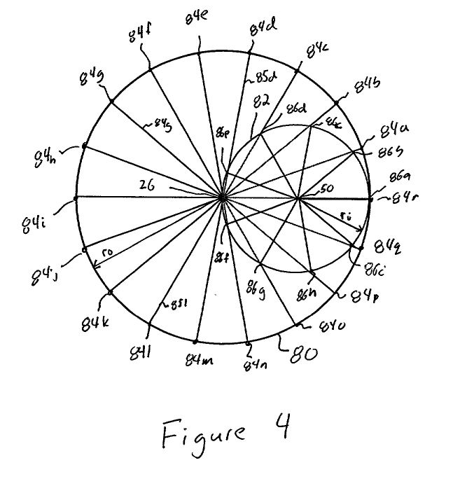

With particular reference to FIGS. 3 and 4, an outer reference circle 80 is defined around the first axis 26 and preferably has a diameter slightly less than the diameter d of the outer rotor 22. An inner reference circle 82 is defined about the second axis 50 and has a diameter slightly less than the diameter d′ of the inner rotor 24. Preferably, the outer reference circle 80 has a circumference that is approximately and more preferably exactly twice the circumference of the inner reference circle 82 of the inner rotor 24 Therefore, as the inner wheel 24 rotates about centerpoint 50 the inner wheel's rotations per minute is approximately and more preferably exactly twice the rotations per minute of the outer wheel 22. As discussed further herein the ratios between the inner rotor 22 and the outer rotor 22 can be other integer values as well (i.e. three, four, etc.) It should be noted that there is a linear relationship between the radius, diameter, and circumference of a circle. Therefore, the ratios between the diameter of the inner rotor 24 and the diameter of the outer rotor 22 is the same as the ratio between the circumference of the inner wheel 24 and the circumference of the outer wheel 22. It should also be noted that in the illustrated embodiment the inner reference circle 82 extends through the first axis 26.

With continued reference to FIGS. 3 and 4, in the illustrated embodiment, the outer reference circle 80 can be divided into eighteen pie sections spaced approximately twenty degrees so as to define outer reference points outer reference points 84a-r. The inner reference circle 82 has nine evenly spaced pie sections at forty degrees intervals defining inner reference points 86a-86g. As mentioned above, the inner reference circle 82 that is preferably one half of the diameter of the outer reference circle 80. That is, the radius rₒ of the outer reverence circle 80 is preferably twice the inner radius r₁ of the inner reference circle 82. The circumference of a circle is a linear relationship with respects to the radius. The well-known equation is c=2πR. Therefore, one-half of a radius yields exactly one-half the circumference. Further, forty degrees of circumference section for the inner circle 82 yields exactly one-half of the circumferential distance of forty degrees circumference section of the outer circle 80. Therefore, twenty degrees (½ of forty degrees) of the outer circle 80 yields the exact same circumferential distance as a forty degrees of the inner circle 82. So as the outer circle 80 rotates about centerpoint 26 and the inner circle 82 rotates about centerpoint 50 and the perimeters of each circle move at the same speed the inner circle 82 will rotates at exactly twice the rotational velocity of the outer circle 80. This rotational scheme is defined as the dual rotation.

By having the inner reference radius rᵢ one-half the length of the outer reference radius rₒ there is an interesting mathematical phenomena. Specifically, as both the inner and outer rotors 24, 22 rotate, the points 86a-i move along lines 85, which extend from points 84a-r to the first axis 26. In other words, as the circles rotate in the dual rotation fashion points 86a-i define a straight line 85 that extends radially out from the first axis 26 of the outer circle 80.

With the foregoing geometric relationships in mind, reference is now made back to FIG. 3 where the inner and outer circles 80 and 82 are superimposed upon the rotor assembly 21 described above. A point 87 is located on the toe portion 58 of each of the legs 52 and lies substantially on or near the inner circle 82 and intersects the outer circle 80 as shown in FIG. 3. In a similar manner, a point 89 is located on the heal portion 56 of each of the legs 52 and also lies substantially on or near the inner circle 82 and intersects the outer circle 80 as shown in FIG. 3. Points 87 and 88 are referred to as the contact points and exist where the circumferences of the inner critical circle 82 and the outer critical circle 80 cross on the point in the rotation defined by a line extending through the point 26 and the point 50 and out to the circle 80.

With continued reference to FIG. 3, the toe surface 64 is defined by a semi circle having a centerpoint at 87 and a radius of 90a. Therefore all points along surface 64 are equidistant from the point 87 at a distance 90a. To reiterate the geometric relationship phenomenon, as the inner and outer rotors 24 and 22 rotate in the dual rotation scheme described above, the point 87 will travel along the line 85. Therefore, rearward surface 32 must be parallel to line 84. In other words, as point 87 travels radially inwardly along line 85 during the dual rotation scheme, the surface 32 must be parallel to radially extending line 85 to avoid interference between surfaces 32 and 64.

In a similar, manner the heel surface 62 is defined by a semi circle having a center point at 89 and a radius 90b. the point 89 travels radially inward along line 85 towards the center of the outer circle 80, the semi circle surface 62 will maintain contact along forward surface 34 because this surface is perpendicular to line 85. The same analysis can be conducted for all of the fins 28 with the respective legs 28 adjacent thereto.

It should be noted that the preferred surface for the first embodiment for surfaces 62 and 64 is a semi circle about a point. The semi circle allows the fins to have non-curved surfaces that radially extend from the outer reference circle 80. In modified embodiments, other circular shapes for the heel and toe surfaces 62 and 64 could be employed with a varying radius.

In addition to having the reference circles 80 and 82 radii (and circumferences) a ratio of two to one, it is also preferable to have the number of fins 28 of the outer rotor twice in quantity as the number of legs 52 of the inner rotor. This integer ratio is helps to promote continuous rotation of the inner and outer rotors 22, 24 and prevents a leg crashed down upon a fin. Of course, as mentioned above, other integer ratios (e.g., three, four, etc.) may also be used in modified embodiments.

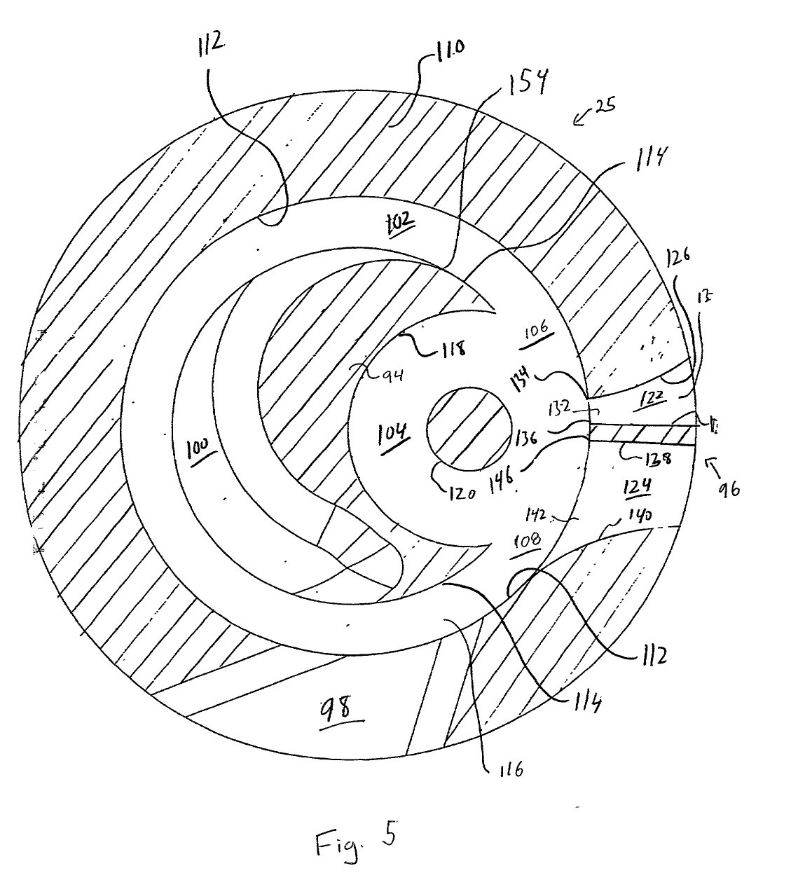

With reference no to FIGS. 1 and 5 there will now be a discussion of the rotor assembly mounted in the housing 25 along with the various components of the apparatus 20 followed by a description of the compression scheme. As seen in FIG. 5, the housing 25 is preferably a unitary designed comprising a central area 94, an exit/entrance portion 96, a discharge region 98, an entrance region 100, an outer rotor annular slot 102, an inner rotor annular slot 104, a high compression region 106, an expansion region 108 and finally an annular support region 110. The outer rotor annular slot 102 is adapted to house the outer rotor 22. The outer rotor 22 can rotate therein and seal against an inward annular surface 112 of the annular support region and an outward annular surface 114 of the central area 94. Further, the annular slot has a surface 116 adapted to support the lower surface of the outer rotor 22. The inner rotor annular slot 104 is defined by an radially inward surface 118 of the central area 94 and a radially outward surface 120 of the central area 94. The radially outward surface 120 is adapted to position inner rotor 24. Further, the radially inward surface 118 is in close engagement with the radially outward surface 60 of the inner rotor 24. Therefore, surfaces 118 and 120 independently cooperate to hold inner rotor 24 and place to rotate about centerpoint 50. More specifically, the outer rotor annular slot 102 and inner rotor annular slot 104 may be used to assist in positioning the outer rotor 22 and inner rotor 24 so both rotors rotate about centerpoints 26 and 50 respectively.

The fluid flow into and out of the rotor assembly 20 is accomplished by the exit/entrance portion 96, the discharge region 98, and finally the entrance region 100. The exit/entrance portion 96 comprises an exit passage 122 and an entrance passage 124. The exit passage 122 comprises a first surface 126, a second surface 128, lower surfaces 130 and upper surface (not shown). A boundary comer is defined at numeral 134 and a second comer portion is indicated at 136. The entrance passage 124 comprises a first surface 138, a second surface 140, lower surface 142 and upper surface (not shown). A corner portion 146 is located at the juncture between inward annular surface 112 and first surface 138.

In a modified embodiment, the location of the exit passage 122 can be adjusted with respects to a compression chamber (defined below) such that the compression ratio between the compression chamber and the pressure at the exit passage 122 is maximized. In such an arrangement, the casing can rotate with respects to the location of the inner rotor 24 and hence adjust the boundary locations 134 and 136 of the exit passage 22. In a similar manner, the entrance passage 124 can also be adjusted.

Although not illustrated, the top of the rotor assembly 21 (see FIG. 1) is preferable sealed with a top plate that can be attached to the housing 25.

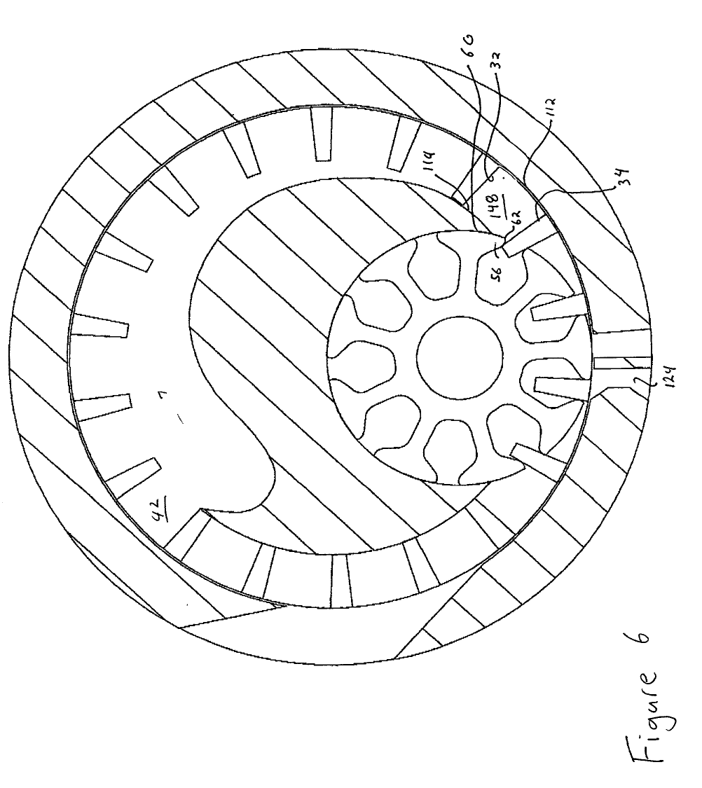

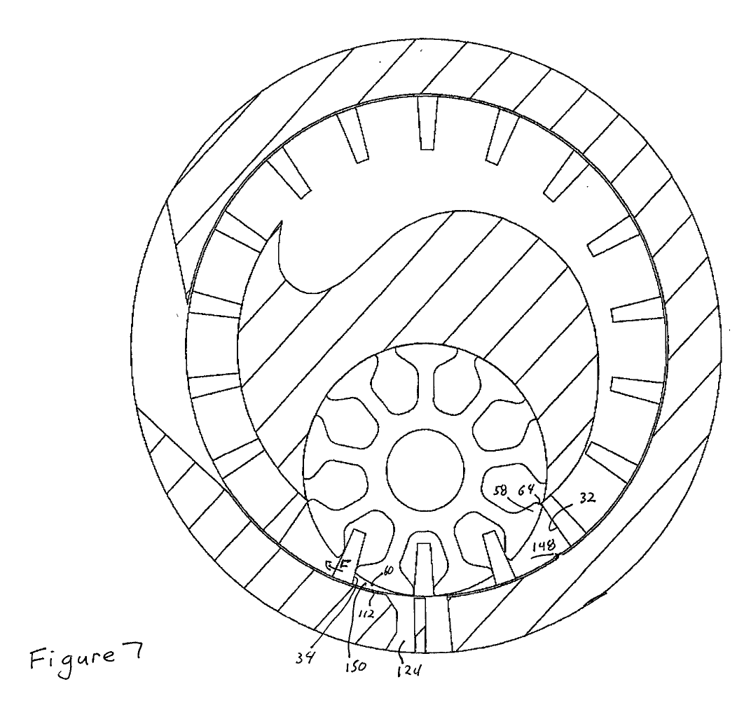

To properly understand the airflow scheme of the engine 20 there will first be a discussion of the chamber volume displacement. With initial reference to FIG. 6, a compression chamber 148 is initially formed by the radially outward surface 60, the forward surface 32, the rearward surface 34, the outward annular surface 114, the radially inward surface 112 and finally the upper and lower surfaces 40, 41 of the outer rotor 22. The compression chamber 148 is formed as soon as the surface 62 of the heal portion 56 engages the radially inward portion of rearward surface 34 The chamber 148 is sealed between the inner rotor 24, the outer rotor 26, and the housing 25. The radially inward portion of the forward surface 32 is in tight communication with radially outward surface 114. Likewise, the radially outward surface of the fins 28 is in close communication with the radially inward surface 112. As the rotors 24 and 22 continue to rotate to a position shown in FIG. 7, the pressure chamber 148 begins to decrease in volume. When, as shown in FIG. 7, the surface 64 of the toe portion 58 engages the radially inward portion of the forward surface 32, the pressure chamber 148 is substantially sealed without the assistance of the radially outward surface 114.

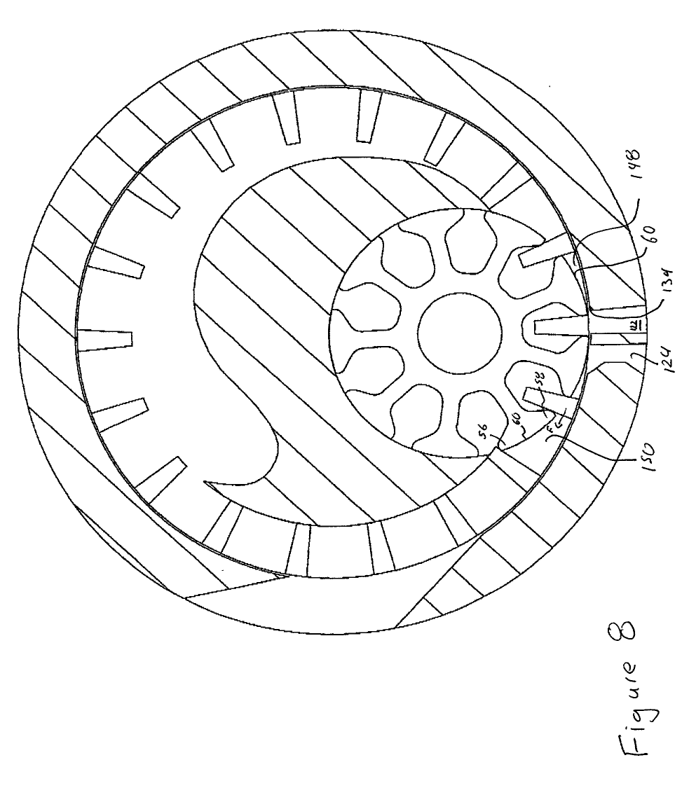

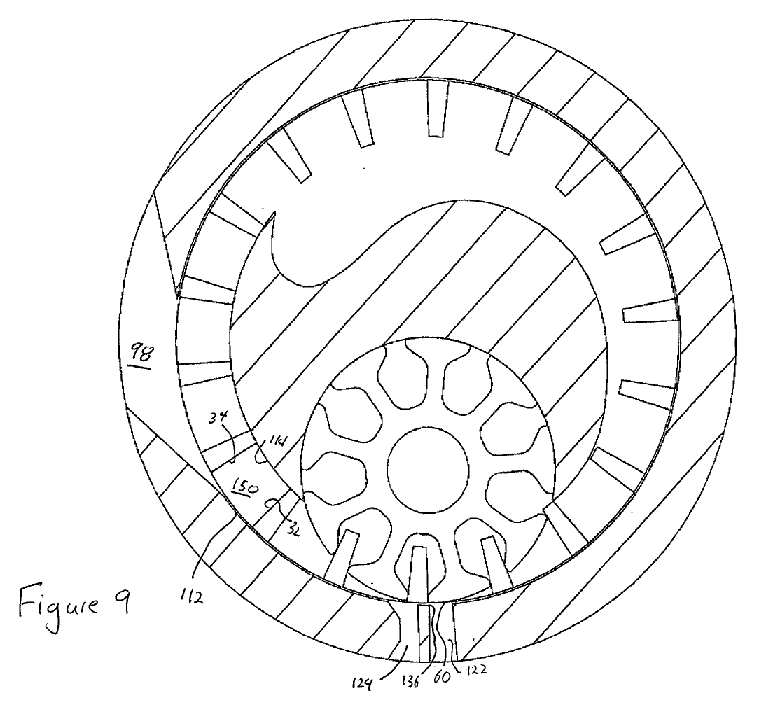

Now referring to FIG. 8, the inner rotor 24 has rotated a few additional degrees clockwise to a position where the radially outward portion of rearward surface 34 of the fin 28 passes the boundary comer 134. At this point the volume of the pressure chamber 148 has been substantially reduced and the pressure chamber 148 is now in communication with the exit passage 122. As shown in FIG. 8, the compressible fluid within pressure chamber 148 still being displaced by radially outward surface 60 as the inner rotor 24 continues to rotate. Finally, as shown in FIG. 9, the heal portion 56 of the leg 52 passes the comer portion 136 and radially outward surface 60 is in engagement with the radially inward surface 112. The contact between radially outward and inward surfaces 60, 112 maintains a seal between the exit passage 122 and the entrance passage 124. At this position, the pressure chamber 148 has been substantially reduced in volume so as to displace the compressible fluid formerly in the pressure chamber 138 into the exit passage 122. As seen in FIG. 2, the radially outward portions of the fins 28 may have a slight tangential taper. This taper receives the comer portions 62, 64 of the toe and heel portions 58 and 56 of the legs 52. Therefore, the tangential taper prevents the compressible fluid from being trapped into the corners between the forward and rearward surfaces 32 and 34 and the housing 25. This is desirable because maximum gas displacement can occur if the compression chamber 148 is completely displaced.

The gas entrance phase will now be discussed with reference again made to FIGS. 7-9. As seen in FIG. 7, gas enters in entrance passage 124 and enters into expansion chamber 150 is initially formed by the radially outward surface 60, the rearward surface 34, the radially inward surface 112 and finally the upper and lower surfaces 40, 41 of the outer rotor 22. As the gas enters the expansion chamber 150, a tangential force F is imparted onto the fin 28 causing the outer rotor 22 to rotate.

As the inner rotor 24 rotates (FIG. 8), the expansion chamber 150 increases in volume. It undesirable to have the expansion chamber 150 sealed and not be in communication with the entrance passage 124 because a low-pressure region would be created producing a counter clock wise force. Thus, although not illustrated in FIG. 8, the expansion chamber 150 should be in communication with the entrance passage 124 as the inner rotor rotates to the position shown in FIG. 8.

It is important to note that the angular duration of the entrance passage affects the power and efficiency of the device. If the entrance passage remains open to the maximum expansion position of the chambers, the gas from the combustor will remain at an elevated pressure for the entire expansion cycle and allow for higher power output. If the entrance passage closes soon after the expansion of the chambers begins, the pressure of the contained gas will decrease as the chamber increases in volume and less gas will be used providing the possibility for greater efficiency. As basic guideline, for an external engine embodiment, the entrance passage to the expansion chambers should remain open for a greater angular duration than the angular duration of the compression chamber port. In this and other embodiments of the device, many port/passage configurations can be used to achieve various effects.

In FIG. 8 the expansion chamber is fully expanded and now defined by the outward annular surface 114, the radially inward surface 112 and forward surface 32c and rearward surface 34d. Finally, the air is subjected to a centrifugal force and ejected through the discharge region 98.

There will now be a discussion of how air or other compressible fluid enters into the semi chamber regions 42 of the outer rotor 22. With reference to FIG. 1, as the outer rotor 22 rotates in the direction indicated by arrow 151, air is drawn in to and through the entrance region 100. The entrance region 100 comprises glide surface 152, which may have a generally downward slope in the radial direction. The rotations per minute of the outer rotor 22 are preferably in the order of magnitude in the thousands to hundreds of thousands with certain materials in certain configurations. At such high-speeds air drawn through the entrance region 100 can be “precompressed” into the semi chambers 42. The compression at this phase is similar to a centrifugal compressor. When the rearward fin 28 of semi chamber 42 passes the position 154 (see FIG. 5) the semi chamber i42 s now substantially sealed and ready for the gas contained therein to pass to the high compression region 106 and be compressed as described above.

The engine 20 describe above can be operated in many different manners. For example, in a first mode of operation, the air or other compressible fluid that is discharged from the exit passage 122 is heated by, for example, passing the fluid through a heat exchanger or a combustion chamber. The heated air is then routed through the entrance passage 124 so as to rotate the outer rotor 22. The air can then be discharged through the exhaust passage 98. By coupling the rotor to an output shaft, a high output engine is formed.

A simple compressor arrangement can be achieved by providing a rotational input to on of the rotors, preferably the outer rotor, and compressing and ejecting the gas as described above in the compression phase of the engine embodiment. The expansion phase of the engine embodiment would, in the compressor application be used preferably to draw low pressure gas into the chambers. The entrance passage would preferably be open for the entire expansion of the chambers and the pressure in this chamber could be further increased by allowing gas to enter the rotor through the enterance region 100 and compressed centrifugally before compression by the inner rotor.

A similar embodiment could be used as a fluid motor or gas expansion motor. In this embodiment, pressurized fluid or gas is provided to the expanding chambers through the entrance passage, causing the rotors to rotate. This rotational energy can be captured by harnessing the shaft torque and speed. In this case it may be preferable to increase the size of the compression port so no work is wasted by compressing the gas or fluid.

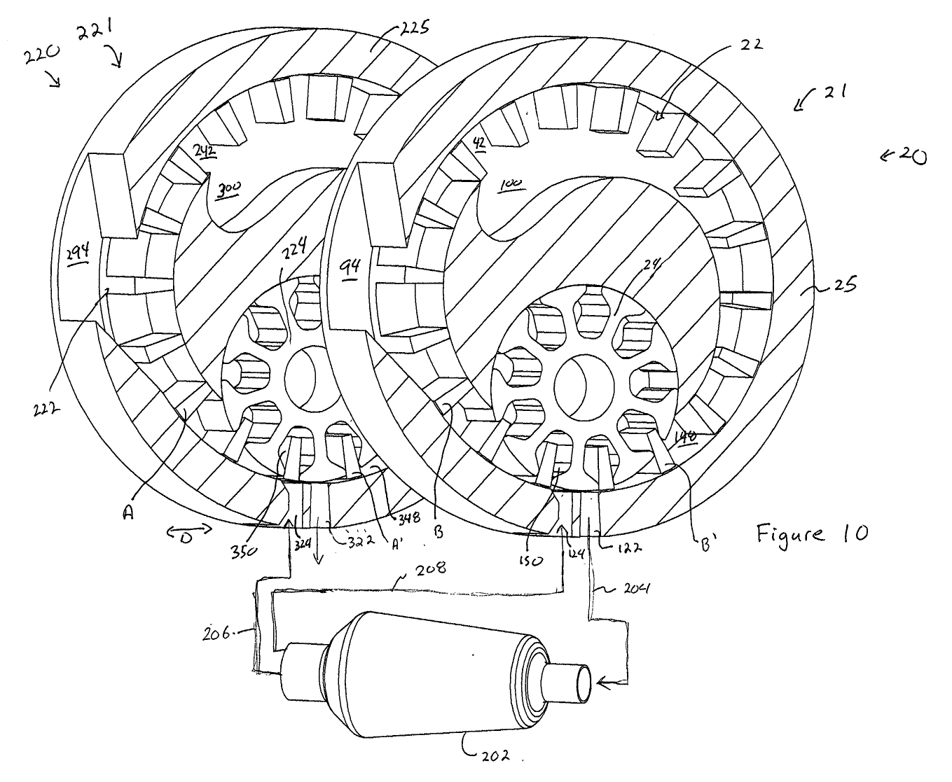

There will now be a description of a second embodiment with initial reference to FIG. 10. This embodiment is substantially similar to the embodiment illustrated in FIGS. 1-9. The main addition is a second engine 220, which is arranged in substantially the same manner as the engine 20 described above. As such, like numbers are used to refer to parts similar to those of FIGS. 1-9 except that the numbers are increased by two hundred.

In this embodiment, the second engine 220 is employed to receive exhaust gas from a combustion chamber or other type of heat exchanger 202. The outer rotors 21, 221 of the first and second rotor assemblies 21, 221 are preferably but not necessarily coupled together such that they rotate in conjunction with one another. The exhaust gas exiting the combustion chamber 202 is of greater volume than the gas entering the combustion chamber 102 through the exit passage 122. The greater volume of fluid is divided and channeled into the into the expansion chambers 150 and 350 of the first and second rotor assemblies 21 and 221. A portion of the output work of the second rotor assembly 221 can be transferred through a shaft (not shown) to the first rotor set and used to compress the air exiting the exit passage 122 of the first rotor assembly 21 that is directed into the combustion chamber 202. The remainder of the work output of the second rotor assembly 221 can be displaced into an output shaft attached to the outer rotor 222. Alternatively, compressed air exiting the exit passage 122 of the second rotor assembly 223 can be utilized for “cold blow” thrust or other use discussed further herein. Further, a portion of the exiting air from the combustion chamber could be channeled off for a “hot blow” thrust or other use also discussed herein.

The external combustion system 202 comprises a passage 204, which is in communication with the exit passage 122 of the first assembly 21, a first exit passage 206, which is in communication with the entrance passage 324 of the second assembly 221, and a second exit passage 208, which is in communication with the entrance passage 124 of the first assembly 21.

The external combustion chamber 202 can be of any conventional design. The important aspect of the external combustion system 202 is the volume of gas increases from the exit to the entrance due to an increase in heat. Therefore the combustion system 202 could be a heat exchanger or other device to increase the temperature of the gas passing therethrough.

The second rotor assembly 221 comprises an outer rotor 222 and an inner rotor 224. The depth of the rotor assembly in the transverse direction is indicated by distance D. The significance of the depth of the second rotor assembly is discussed further below.

There will now be a discussion of the operations of the second embodiment with emphasis drawn towards the amount of change of volumetric flow of gas in the external combustion chamber 202 corresponding to the volumetric ratio of the semi chambers 42, 242 of the first and second assemblies 21, 221.

As the compressed gas (presumably air) is ejected from the exit region 122 of the first rotor assembly 21, the compressed air blows from the first engine 20 through the passage 204 into the combustion chamber 202. The fuel in the combustion chamber is ignited. This reaction causes and expansion of the gas at a near constant pressure. The combusted gas then exits through the exit passages 206, 208. It should be noted that the external combustion system is an open system therefore there must be a slight pressure decrease to induce a flow of gas therethrough. However, the increase of volume of exiting gas is utilized to create work.

The increase in volume of gas is accommodated by providing expansion chambers 150, 350 in the first and second rotor assemblies 21 and 221. The forward and rearward tangential surface areas of the fins 28, 228 that are exposed to the expansion chambers 150, 350 is determined in part by the depth D of the assemblies 21, 221. Assuming the other dimensions are similar for the first and second assemblies 21, 221, the tangential forward and rearward surface areas of the fins 28, 288 are proportional to the depth D. Because the exposed rearward surface area is larger than exposed forward surface area, the tangential force upon the outer rotors 22, 222 from the pressure in expansion chambers 150, 350 will be in the clockwise direction. The magnitude of this substantially tangential force is a function of the rearward surfaced area minus the forward surface area multiplied by the depth of the fins 28, 228 and multiplied by the pressure within the exit chamber regions 124, 324.

As the outer rotor 222 rotates in the clockwise direction the gas housed in the semi chambers 242 is expelled out the discharge region 294. Therefore, the pressure in the semi chambers 242 down stream of the expansion chamber 350 is atmospheric or very close thereto while the pressure in the expansion chamber 350 is near that of the combustion chamber 202. As such, the pressure difference upon the fin labeled “A” causes a substantial pressure force causing a clockwise rotation of the outer rotor 222. In a similar manner, the fin labeled “B” in the first engine 20 is also subjected to a pressure differential, which cases clockwise rotation of the outer rotor 22.

For increased efficiency, the pressure of the gas in the expansion chamber should be as close to atmospheric pressure as possible when each chamber reaches the exhaust port 94 or 294. In this case the port 124 and 324 must be open for only part of the expansion chamber expansion phase. In this case the pressure differential across fins A and B will be very small and the power will result from the difference in surface area of the trailing face 34 and the leading face 32 during the expansion cycle.

The compression chambers 348, 148 have a counter clockwise torque applied upon fins A′, B′. As describe above, the counter clockwise torque is a function of the surface area of the fins exposed to the compression chamber 348, 148. Even though the pressure in entrance passages 324, 124 is less than the pressure in the compression chambers 348, 148 the net surface area in the rearward direction for the outer rotor 222, 22 is greater and hence the differential tangential surface area is greater in the clockwise direction and hence the gas exiting the combustion chamber 202 can self-propel the rotor assemblies 221, 21.

It should be noted that the combined effective surface area of the compression chambers of the two rotor assemblies 221, 221 causing a clockwise rotation will only be less than the effective surface area of the expansion chambers if the compression chamber of the second rotor set 221 is not used for compression. To achieve this situation, the port 322 needs to be large enough to expel any gas contained in the chambers without compressing it.

In another embodiment, a clockwise rotational force can be generated by increasing the angular duration of the opening of ports 124 and 324 so the pressure acting on the expansion chambers is on average higher than the pressure in the compression chambers.

In a modified embodiment, a portion of the compressed air can be directed through the combustor 202 to run the compressor and the remainder of the gas can be directed through other conduit for “cold blow” work. For example, if the combustor achives a 3:1 expansion ratio, then half of the compressed air from port 122 (or also port 322) could be used for cold-blow thrust or other use, leaving half the volume to be heated in the combustion chamber. The volume from the combustor will then be twice the compressed volume from port 122 and this increased volume can be used to power the rotor set and to overcome friction, heat, and leakage losses. Many combinations of effects can be used to achieve different performance and efficiency goals. It is important to note, also, that the first and second rotor assemblies 21, 221 do not have to be connected because there are applications where it would be advantageous to allow the outer rotors to rotate independent of one another.

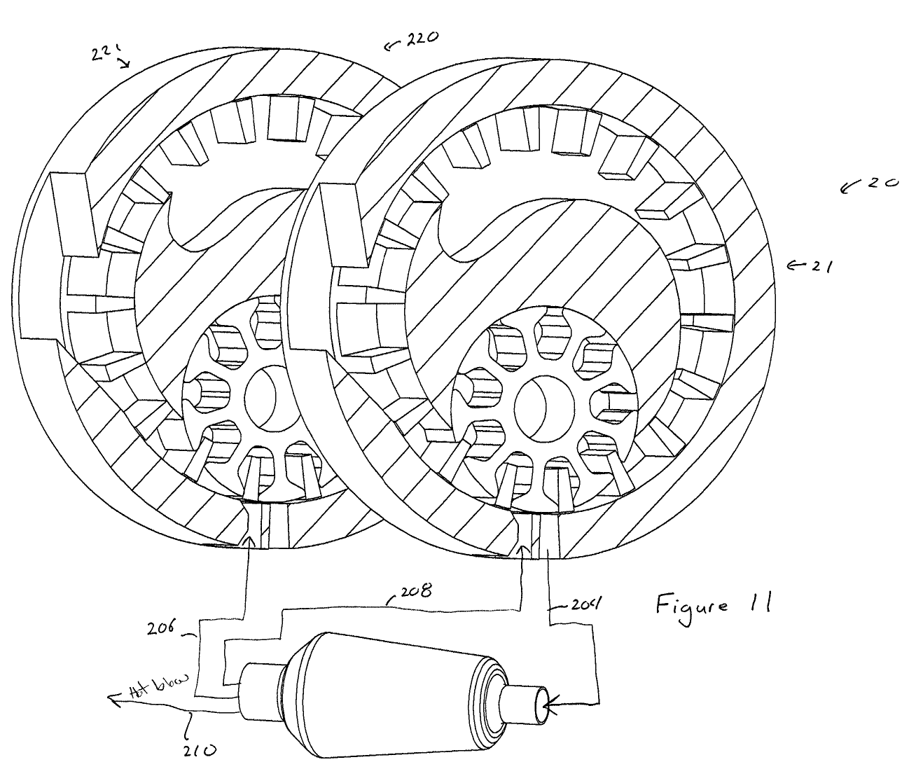

FIG. 11 shows a variation of the second embodiment wherein a portion of the exhaust gas from the combustion chamber 202 is directed through a hot blow conduit 210 and can be used for work. In such an embodiment, the depth of the second engine 220 can be reduced because a portion of the combusted gas is directed to the hot blow conduit 220. Hence, the main function of the second engine 220 is to supply a clockwise torque to assist in compressing the air in the compression chambers 148 of the first engine to supply compressed air to the combustion chamber 202. In another embodiment, the second engine could be removed entirely and only the first engine 20 would provide compressed air to the combustion chamber 202. In such an arrangement, the exiting gas from the external combustion chamber 202 which ws not required to keep the rotor set spinning could be used for a “hot blow” thrust or other use.

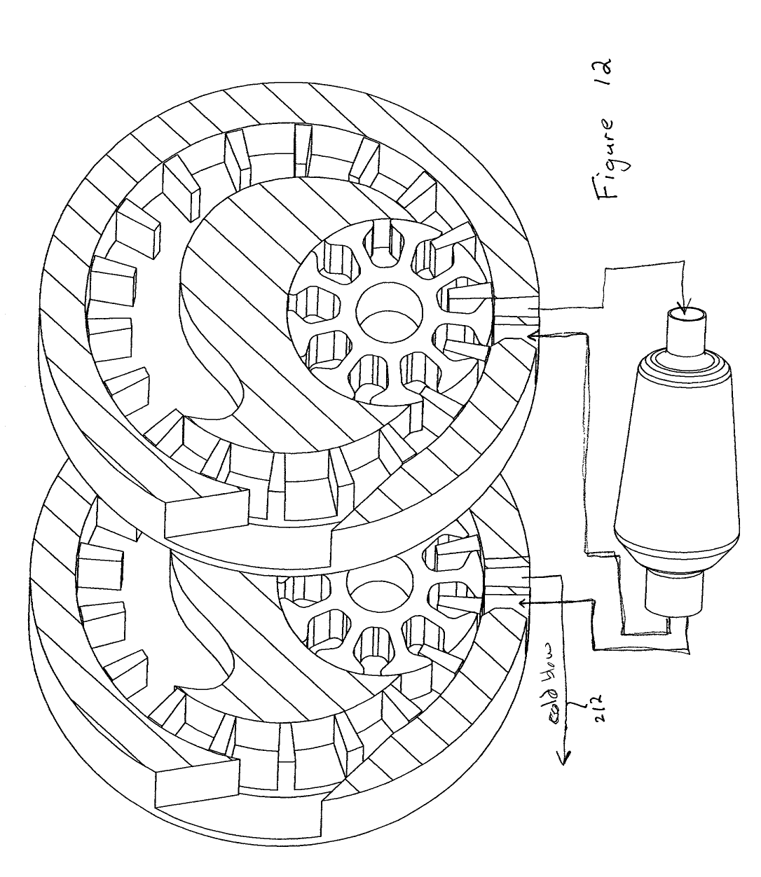

FIG. 12 shows another variation of the second embodiment where the exit passage 322 of the second engine 220 in communication with a cold blow conduit 212. In this version, the work output from the second engine 220 is transformed to a compressed gas that is not directly disbursed from the external combustion chamber 202. This embodiment shown in FIG. 12 is particularly advantageous when compressed air is desired without the contaminants from the gas expelled from combustion chamber 202 or with the heat generated by the combustion chamber. Note that the angular duration of the port openings in FIGS. 6-12 are schematic and are not optimized for any particular embodiment described here.

For the above described embodiments, it should be noted that the second rotor assembly 221 does not necessarily need to be housed together with the first rotor assembly 21 to have a functioning apparatus.

We have thus far discussed two embodiments of the present invention, both of which employ a single outer rotor 22 and a single inner rotor 24. There will now be a discussion of a third embodiment employing two inner rotors while still maintaining a two to one ratio between the outer reference circle 380 of the outer rotor 322 and the inner reference circle of the inner rotors 324. In a similar numbering fashion as the second embodiment, the numerals designating the components of the third embodiment will correspond, where possible, to the numerals describing similar components except the numeric values will be increased by three hundred.

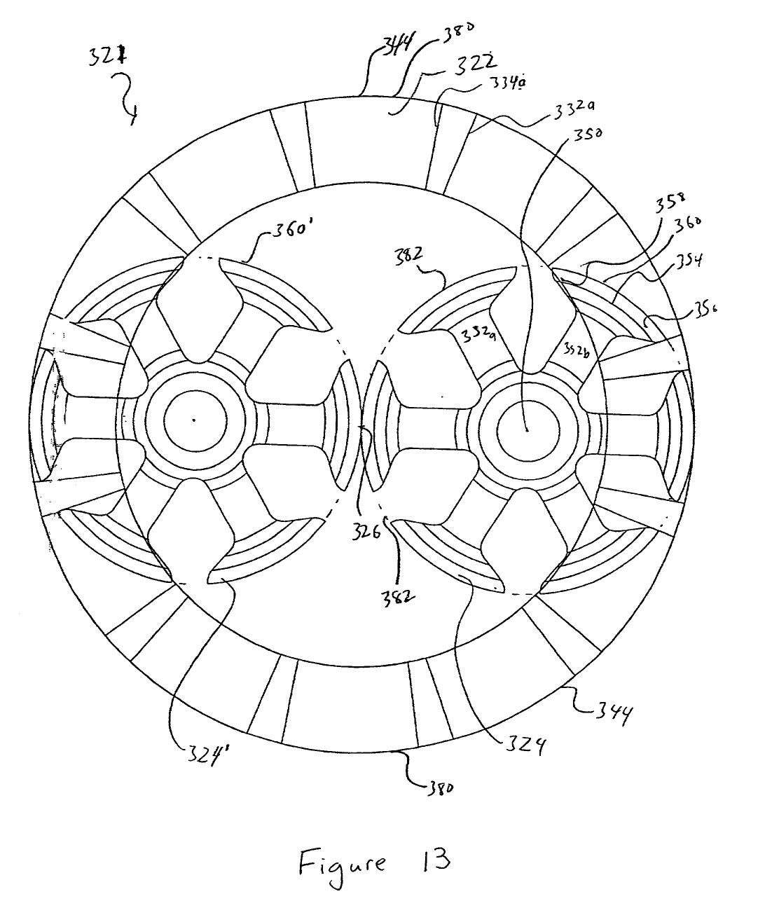

As shown in FIG. 13, the rotor assembly 321 comprises an outer rotor 321 a first inner rotor 324 and a second inner rotor 324′.

The outer rotor 321 is very similar to the outer rotors 22 and 222 in the first and second embodiments except for slightly different dimensions of the forward and rearward surfaces 332 and 334. The centerpoint 326 is the center of rotation for the outer rotor 322. The reference circle 380 for the outer rotor coincides with the peripheral edge 344 also having a centerpoint 326.

The inner rotors 324 and 324′ are substantially similar and hence inner rotor 324 will be described in detail with the understanding the description also relates to inner rotor 324′.

The inner rotor 324 comprises a plurality of legs 352 where each leg has a foot portion 354. The foot portion 354 comprises a heel portion 356, a toe portion 358, and a radial outward surface 360. The radial outward surface 360 defines a circle about point 350. The inner reference circle for the inner rotor 324 is indicated at 382 and coincides with the circle defined by radially outward surface 360.

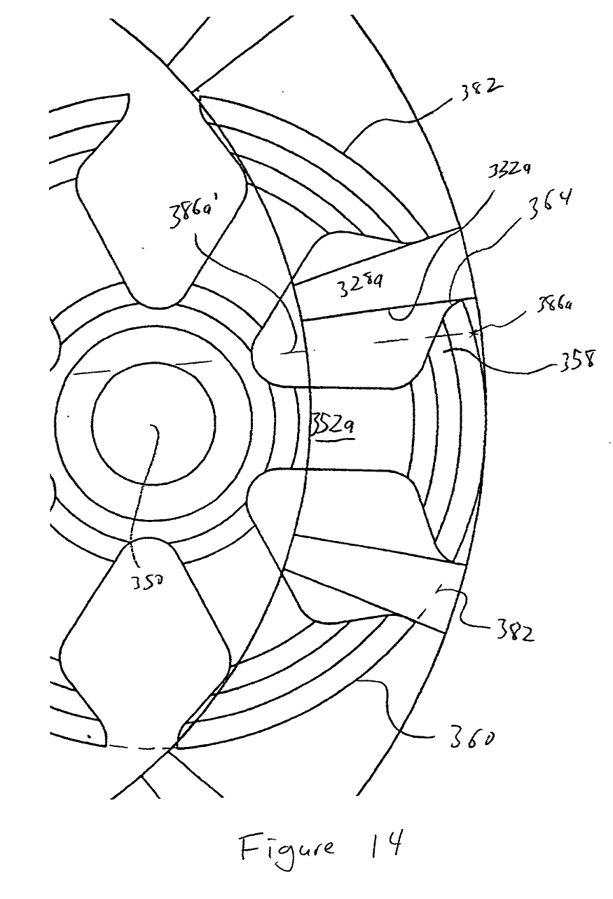

As seen in FIG. 14, the forward surface 364 of the toe portion 358 is semi circular about point 386a. The point 386a lying along the inner reference circle 382 (as well as the circle defined by radially outward surfaces 360). The significance of having the reference point at this radially outward extreme location from the centerpoint: 350 is discussed further herein.

We will now describe the forward and a rearward surfaces 332 and 334 of the fins 328. The analysis of the forward and reward surfaces 322 and 334 is very similar to the analysis of. surfaces 32 and 34 of the first embodiment discussed above referring to FIG. 3. The main difference in the third embodiment is the point 386 is located on the radially outward surface 360, whereas in the first embodiment the point 86 is located a distance radially inward from the radial outward surface 60.

The line 386a′ extends from the reference point 386a to the centerpoint 326 of the outer reference circle 380 (see FIGS. 13 and 14). When the inner and outer rotors 324 and 322 engage in the dual rotation scheme, the reference point 386a travels radially inward along line 386a′. Therefore, forward surface 332a must be parallel to the line 386a′. A similar analysis can be conducted for the rest of the surfaces 364 and 362 of the inner rotors 324 and 324′.

By having the outer reference circle 382 coexisting with the radially outward surface 360 or slightly radially outward from radially outward surface 360, the rotor assembly 321 can fit the second rotor 324′ into the housing as well.

In a preferred form, the inner reference circles 382 and 382a′ are a small tolerance distance from the radially outward surfaces 360 and 360′ to avoid interference between these surfaces at the centerpoint location 326.

It should be noted that the third embodiment could be used for an external combustion engine in a similar manner as shown in the second embodiment.

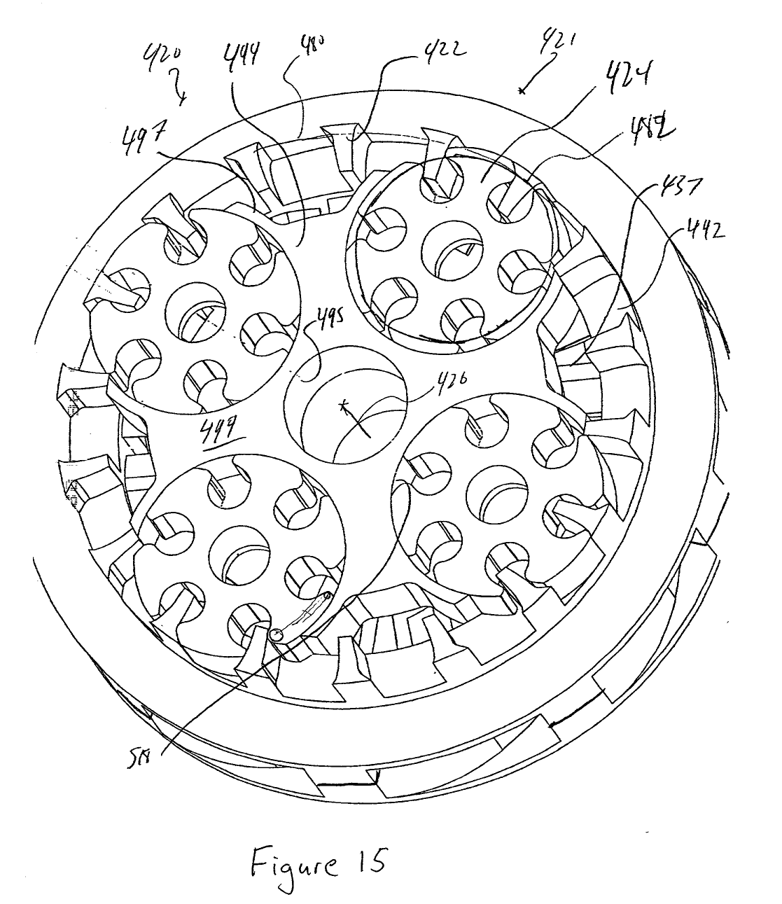

A fourth embodiment is shown in FIG. 15 where four inner rotors are employed. This fourth embodiment has advantages including allowing a throughput shaft that is attached to the outer rotor 422. As with the previous embodiments, where possible the numerals substantially correspond with the first embodiment except increased by four hundred.

The apparatus 420 has a rotor assembly 421 that comprises an outer rotor 422 and a plurality of inner rotors 424a-424d. The outer rotor has a reference circle 480 and a center of rotation indicated about axis 426. Likewise, the inner rotors 424 have been inner reference circle 482. In a similar manner with the previous embodiments the relationship between the circumference of the inner reference circle and the outer reference circle 482 and 480 is a ratio that is an integer and in this embodiment a ratio of 3-1. Further, the outer rotor has 18 fins and the inner rotors have six legs (a ratio of 3-1). It should be noted that although the fourth embodiment discloses four interior rotors 424, there can be one-four interior rotors. However, having four interior rotors as particular benefits of balancing the force upon the central shaft described further herein.

One aspect of this embodiment is that the toe and heal of the inner rotor feet preferably have tip radius center points on opposite sides of the inner rotor reference circle. For example, the reference circle of the inner rotor is, in this example, ⅓ the diameter of the outer rotor reference circle. Once this relationship is established, the heel center point of the feet of the inner rotor is positioned on the inside of the inner rotor reference circle. The toe center point is then positioned on the outside of the inner rotor reference circle. (This is shown in FIG. 15 on one of the feet of the bottom left inner rotor.)

The following is a description of the advantages of this heel-toe center point position arrangement for this multi-inner rotor design. If an outer rotor reference diameter to inner rotor reference diameter of greater than 2:1 (eg. 3:1, 4:1. 5:1, etc.) is used, then the toe and heel tip center points of the inner rotor do not describe a straight line along the radius of the outer rotor. Instead these points on the inner rotor would describe a distorted “figure eight” type of path. This would cause the inner and outer rotors to either interfere during the rotation or to not seal against each other during critical phases of the rotation. By moving one or the other of the heel or the toe tip center points to one side (inside or outside) of the inner rotor reference circle and the other tip center to the opposite side of the inner rotor reference circle, the figure eight path described by the inner rotor heel and toe tip centers on the outer rotor can be distorted enough to allow the inner rotor to seal against the outer rotor completely during the compression cycle and not at all during the expansion cycle. Conversely, reversing this shape, or reversing the rotation of the rotor assembly can achieve a seal between the inner and outer rotors during the expansion phase but no seal during the compression phase. The offset of the heal and toe tip center points from the inner rotor reference circle is determined by the radial depth of the outer rotor fins. Specifically, the greater the outer rotor radial fin depth, the greater the offset of the inner rotor tip centers on either side of the inner rotor reference circle.

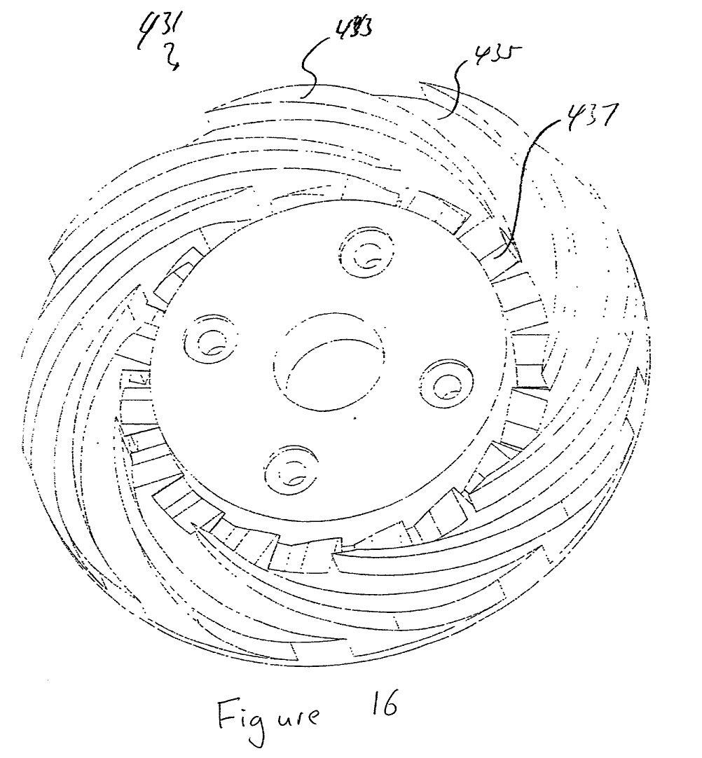

The outer fin further comprises a scoop region 431 best shown in FIG. 16, which shows the backside of one of the rotor assembly support 420 of FIG. 15. As seen in FIG. 16, the scoop region 437 comprises a plurality of vanes 433 define channels 435 that channel the air can generally and radially inward to the longitudinal extensions 437. Now referring to FIG. 16, the extensions 437 channel air into the chambers 442. The scoop region 431 is connected to and can be a unitary structure with the outer rotor 422. FIG. 15 shows an embodiment where two apparatuses 420 are positioned in a back-to-back arrangement having two outer rotors 422 and eight inner rotors 424.

The apparatus 420 further comprises a central frame member 494 that has a central open region 495 and annular interior surfaces 518 that are adapted to house the inner rotors 424. Further, a radially recessed region 497 allows communication to the longitudinal extensions 437 of the scoop region 431.

Finally, the apparatus 420 has a housing (not shown) that is. connected to the front face 499 of the central frame member 494. The housing provides a seal in a similar manner to the housing is shown in FIG. 1, except a plurality of entrance and exit ports could be provided for each interior rotor 424. Further, the previous examples of employing a combustor is possible with this embodiment where the input and output ports would be properly directed to and from the combustor to comprise the various embodiments creating hot blows, cold blows, or torques on driveshafts through an apparatus.

As with the previous embodiments, the apparatus can be used as a steam engine, air motor, flow meter etc.

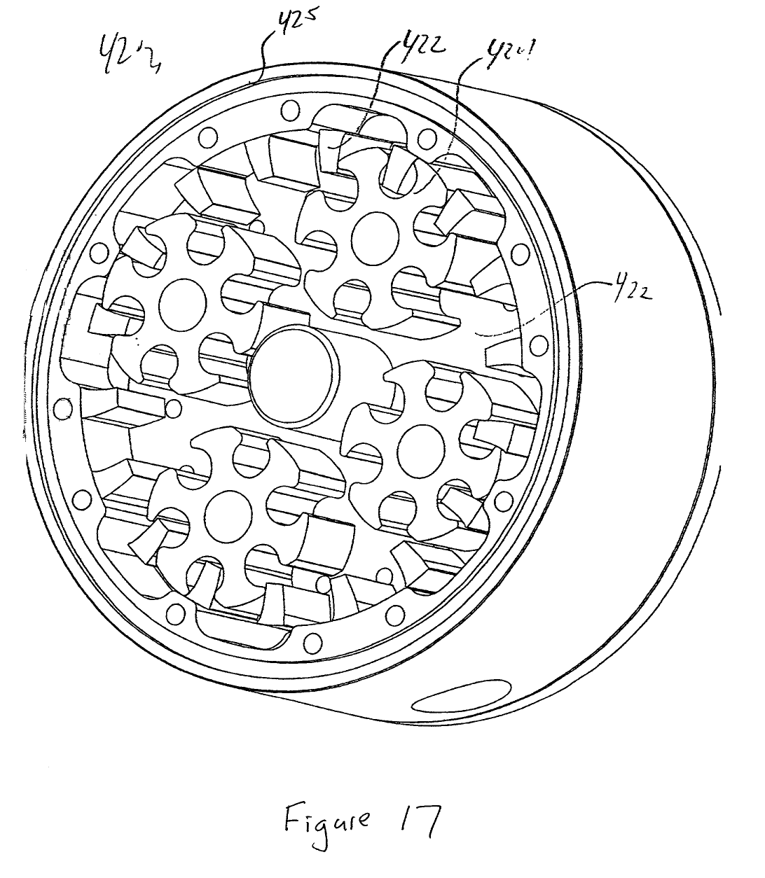

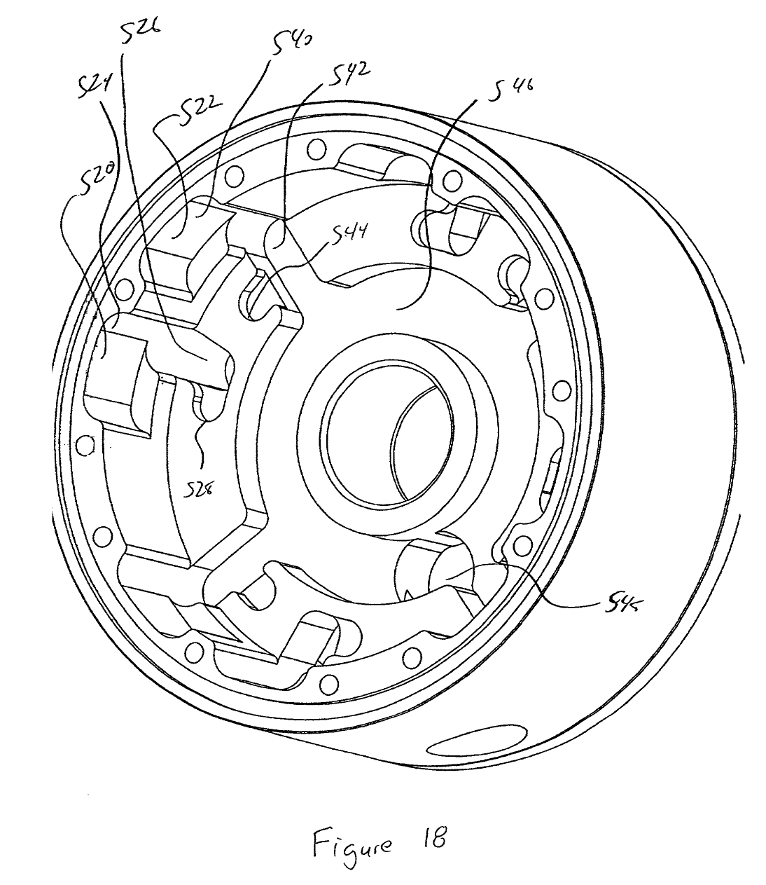

FIG. 17 shows a pump version for the fourth embodiment where in general the entry and exit ports are modified to allow exit ports to be communication with any chamber that is displaced in volume to prevent compression of a fluid. The housing 425 is best shown in FIG. 18 and comprises a plurality of entrance ports 520 and exit ports 522. The entrance ports 520 comprise a radial outward slot portion 524, an axial conduit 526, and a toe portion passage 528.

The exit ports 522 comprise a radial outward slot portion 541 a radially extending slot 542 and a toe portion slot 544. The radially extending slot and toe portion slot 542 and 544 are in communication with one another and are in communication with a central annular slot region 546 which is in turn in communication to the axial conduit 548.

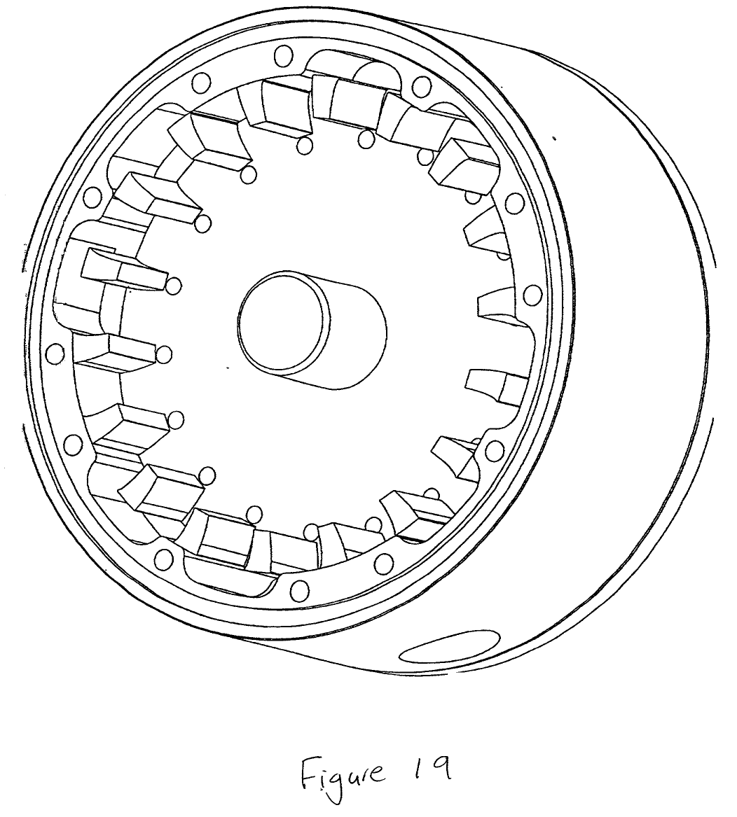

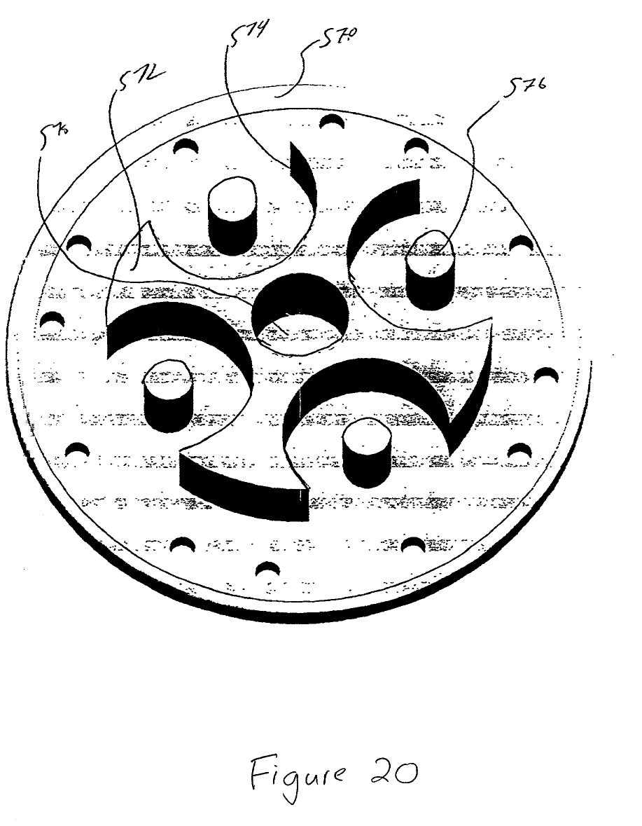

As shown in FIG. 19, the outer rotor 560 is similar to the outer rotors discussed above, with the exception a plurality of ports 562 are provided and are adapted to communicate with the toe portion passages 528. FIG. 23 shows an endcap 570 that is adapted to the mounted upon the pump assembly shown in FIG. 18. The endcap 570 has a center crossmember 572 that provides a plurality of surfaces 574 that are adapted to house the interior rotors. The extensions 576 are adapted to extend to the central shaft of the interior rotors and allowing the interior rotors to rotate their around. The central region 578 is open and allows a shaft (not shown) topass therethrough.

The pump embodiment can be used as a flow meter as well. The mufti interior rotor embodiment is particularly advantageous because the center shaft can extend therethrough and the load balance upon the shaft is desirable where the primary force upon the shaft is the torque caused by the force of the inner rotors acting upon outer rotor.

While the invention is described in the context of specific embodiments described above, it should be understood, that is the invention should not be limited the particular forms disclosed, but, on the contrary, the intention is to cover all modifications, equivalents and alternatives falling within the spirit and scope of the invention as expressed in the appended claims.

I claim:

1. An engine comprising
a housing comprising a first inner surface, a first outer surface, a second inner surface, a second outer surface, an opening duct and an exit passage positioned on the first inner surface;
an outer rotor journalled for rotation about a first axis between the first outer surface and the first inner surface; the outer rotor comprising a plurality of fins that extends towards the first axis, the fins defining, at least in part, a first chamber;
an inner rotor journalled for rotation about a second axis between the second inner surface and the second outer surface, the second axis being parallel to the first axis, the inner rotor comprising at least a first leg having a distal end comprising a heal portion and a foot portion, the distal end of the first leg configured to fit within the first chamber of the outer rotor;
wherein as the inner and outer rotors rotate from a first position to a second position a fluid is drawn into the first chamber through the opening duct, as the first and second rotors rotate to a third position, the first chamber becomes substantially sealed between the first outer surface, the outer rotor, the housing and the distal end of the first leg, as the inner and outer rotor rotate to a fourth condition, the first chamber is compressed and is substantially sealed between the outer rotor, the housing and the distal end of the first leg, as the inner and outer rotor rotate to a fifth position, the first chamber is further compressed further and the fluid is discharged through the exit passage which is now in communication with the first chamber.

2. An engine as in claim 1, comprising a discharge passage and an entrance passage positioned on the first inner surface.

3. An engine as in claim 2, wherein as the inner and outer rotors rotate to a sixth position, fluid is dawn into the first chamber through the entrance passage, the first chamber being defined by the housing, the outer rotor and the distal end of the first leg, as the inner and outer rotors rotate to a seventh position, the fluid in the first chamber is discharged through the discharge passage.

4. An engine as in claim 3, comprising a expansion chamber that has an inlet in communication with the exit passage and an outlet in communication with the entrance passage.

5. An engine as in claim 4, wherein the expansion chamber comprises a combustion chamber.

6. An engine as in claim 5, wherein the expansion chamber comprises a heat exchanger.

7. An engine as in claim 1, wherein the housing further comprises a third inner surface a third outer surface, the engine further comprises a second inner rotor journalled for rotation about a third axis between the third inner surface and the third outer surface, the third axis being parallel to the first axis and the second axis, the second inner rotor comprising at least a first leg having a distal end comprising a heal portion and a foot portion, the distal end of the first leg configured to fit within the first chamber of the outer rotor.

8. A method for compressing a fluid comprising
providing an engine comprising a housing, an inner rotor and an outer rotor,
rotating the inner rotor and the outer rotors rotate to a first position so as to draw fluid into a first chamber through an opening duct formed in a housing;
rotating the first and second rotors rotate to a second position so as to substantially seal the first chamber between a first outer surface of the housing, the outer rotor, the housing and a distal end of a first leg of the inner rotor;
rotating the inner and outer rotor rotate to a third position so as to compress the first chamber is compressed, which is substantially sealed between the outer rotor, the housing and the distal end of the first leg;
rotating the inner and outer rotor rotate to a fourth position so as to further compress the first chamber and to discharge the fluid through the exit passage formed in the housing.
